(19) United States
(12) Patent Application Publication
(10) Pub. No.: US 2026/0251806 A1
(43) Pub. Date: Aug. 27, 2026

(54) SYSTEMS AND METHODS FOR ENHANCED MULTIPATH DIFFERENTIATION

(71) Applicant: TrustPoint, Inc., Herndon, VA (US)

(72) Inventor: Patrick SHANNON, Mountain View, CA (US)

(73) Assignee: TrustPoint, Inc., Herndon, VA (US)

(21) Appl. No.: 19/482,948

(22) PCT Filed: Mar. 1, 2024
(86) PCT No.: PCT/US2024/018061

§ 371 Date: Nov. 10, 2025

Related U.S. Application Data
(60) Provisional application No. 63/449,138, filed on Mar. 1, 2023.

(51) Int. Cl. G01S 19/42; H04B 1/7073; H04B 1/711

(52) U.S. Cl. CPC G01S 19/428; H04B 1/7073; H04B 1/711; H04B 2201/70715

(57) ABSTRACT

Some implementations herein relate to a device that receives and processes multiple spread spectrum signals corresponding to multiple linear frequency modulated (LFM) signals, including a multipath LFM signal having a directly received signal component and an indirectly received signal component. The device may estimate, based on transmission times and transmission positions of the multiple spread spectrum signals and the multiple LFM signals, a position of the device, a time at which the device was at the position, times of arrival of the directly received signal component and the indirectly received signal component, and a time difference of arrival between the times of arrival of the directly received signal component and the indirectly received signal component. The device may estimate, based on the transmission positions, the position of the device, and the time difference of arrival, a range to the surface relative to the position of the device.

### CROSS-REFERENCE TO RELATED APPLICATION

This application claims the benefit of U.S. Provisional Application No. 63/449,138, filed Mar. 1, 2023, which is incorporated herein by reference in its entirety. The present disclosure contains subject matter related to that disclosed in PCT/US2022/014274, filed on Jan. 28, 2022, which is incorporated herein by reference in its entirety.

### BACKGROUND

Multipath propagation occurs when a transmitted signal travels from a transmitter to a receiver and arrives via multiple paths due to reflections, diffraction, and/or scattering in the surrounding environment. These multiple paths can result in the receiver receiving several copies of the transmitted signal at slightly different times and with varying signal strengths.

### SUMMARY

Some implementations provided herein relate to a method associated with enhanced multipath differentiation. The method may include receiving, by a device, multiple spread spectrum signals and multiple linear frequency modulated signals, wherein the multiple linear frequency modulated signals include a multipath linear frequency modulated signal having a directly received signal component and an indirectly received signal component, and wherein the indirectly received signal component is reflected from a surface; receiving signal information indicating: transmission times of the multiple spread spectrum signals and the multiple linear frequency modulated signals, and transmission positions from which the multiple spread spectrum signals and the multiple linear frequency modulated signals were transmitted; estimating, by the device and based on the transmission times and the transmission positions: a position of the device, a time at which the device was at the position, times of arrival of the directly received signal component and the indirectly received signal component, and a time difference of arrival between the times of arrival of the directly received signal component and the indirectly received signal component; and estimating, by the device and based on the transmission positions, the position of the device, and the time difference of arrival, a range to the surface relative to the position of the device.

Some implementations described herein relate to transceiver device including one or more memories; and one or more processors, communicatively coupled to the one or more memories, configured to: receive multiple spread spectrum signals corresponding to multiple linear frequency modulated signals, wherein the multiple linear frequency modulated signals include a multipath linear frequency modulated signal having a directly received signal component and an indirectly received signal component, and wherein the indirectly received signal component is reflected from a surface; receive signal information indicating: transmission times of the multiple spread spectrum signals and the multiple linear frequency modulated signals, and transmission positions from which the multiple spread spectrum signals and the multiple linear frequency modulated signals were transmitted; estimate, based on the transmission times and the transmission positions: a position of the transceiver device, a time at which the transceiver device was at the position, times of arrival of the directly received signal component and the indirectly received signal component, and a time difference of arrival between the times of arrival of the directly received signal component and the indirectly received signal component; and estimate, based on the transmission positions, the position of the device, and the time difference of arrival, a range to the surface relative to the position of the device.

Some implementations described herein relate to a non-transitory computer-readable medium storing a set of instructions, the set of instructions including one or more instructions that, when executed by one or more processors of a device, cause the device to: receive multiple spread spectrum signals corresponding to multiple linear frequency modulated signals, wherein the multiple linear frequency modulated signals include a multipath linear frequency modulated signal having a directly received signal component and an indirectly received signal component, and wherein the indirectly received signal component is reflected from a surface; receive signal information indicating: transmission times of the multiple spread spectrum signals and the multiple linear frequency modulated signals, and transmission positions from which the multiple spread spectrum signals and the multiple linear frequency modulated signals were transmitted; estimate, based on the transmission times and the transmission positions: a position of the transceiver device, a time at which the transceiver device was at the position, times of arrival of the directly received signal component and the indirectly received signal component, and a time difference of arrival between the times of arrival of the directly received signal component and the indirectly received signal component; and estimate, based on the transmission positions, the position of the device, and the time difference of arrival, a range to the surface relative to the position of the device.

### BRIEF DESCRIPTION OF THE DRAWINGS

FIGS. 1A-1G are diagrams of an example associated with enhanced multipath differentiation, according to some embodiments of the present disclosure.

FIG. 2 is a diagram of an example environment in which systems and/or methods described herein may be implemented, according to some embodiments of the present disclosure.

FIG. 3 is a diagram of example components of a device associated with enhanced multipath differentiation, according to some embodiments of the present disclosure.

FIG. 4 is a flowchart of an example process associated with enhanced multipath differentiation, according to some embodiments of the present disclosure.

### DETAILED DESCRIPTION OF EXAMPLE EMBODIMENTS

The following detailed description of example embodiments refers to the accompanying drawings. The same reference numbers in different drawings may identify the same or similar elements.

Geolocation satellite systems, such as global navigation satellite systems (GNSSs) transmit data, via GNSS signals (e.g., direct sequence spread spectrum (DSSS) signals), indicating position and timing information (e.g., satellite ephemeris information, clock correction information, almanac data, and/or atmospheric condition information, among other examples). A transceiver device (e.g., a user equipment (UE), among other examples) receives and processes (e.g., using one or more correlation and/or demodulation techniques, among other examples) the GNSS signals to derive position, velocity, and time (PVT) solutions, which enables precise navigation and/or timing functionalities.

In some cases, the transmitted GNSS signals (e.g., transmitted by one or more GNSS satellites) are affected by multipath propagation, such as when the GNSS signals encounter surfaces (e.g., of objects) and are reflected, diffracted, and/or scattered causing the GNSS signals to take multiple paths to reach the transceiver device. Multipath propagation can lead to multipath interference (e.g., which is also referred to as multipath fading or multipath distortion). Multipath interference occurs when GNSS signals, arriving at the receiver via the multiple paths, interfere with each other destructively or constructively. As an example, destructive interference occurs when the GNSS signals arriving via the multiple paths have opposite phases that cancel each other out, resulting in GNSS signal attenuation or fading. This can lead to drops in GNSS signal strength or data errors, among other examples. As another example, constructive interference occurs when GNSS signals arriving via the multiple paths different paths have similar phases that reinforce each other, resulting in GNSS signal enhancement. This can lead to GNSS signal distortion and difficulty in decoding the transmitted data, among other examples. Accordingly, multipath interference can degrade the accuracy and reliability of GNSS positioning and timing solutions generated by the transceiver device.

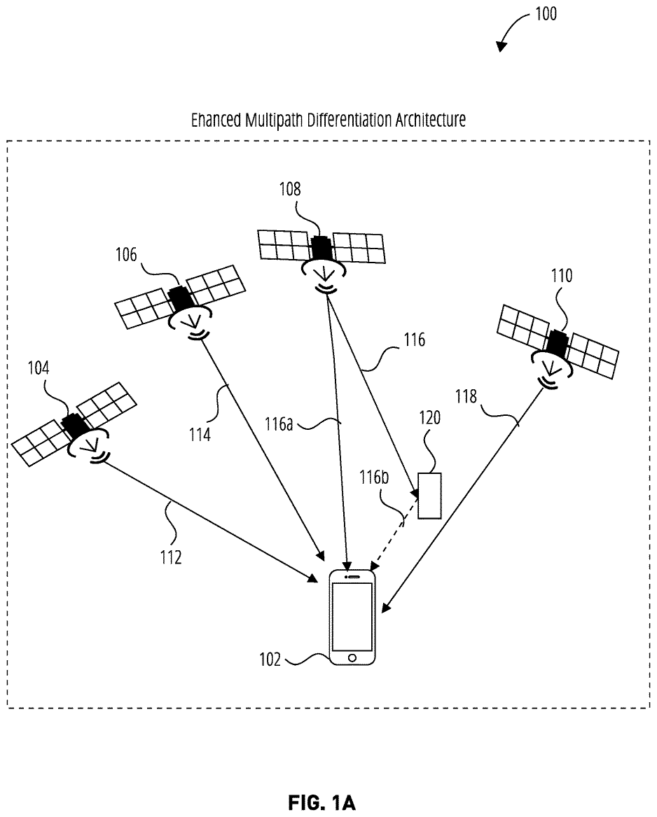

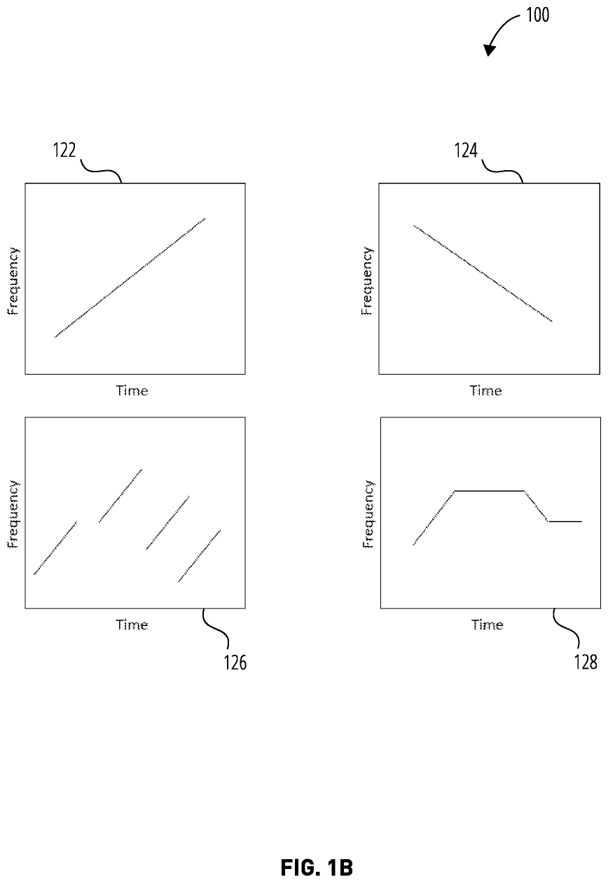

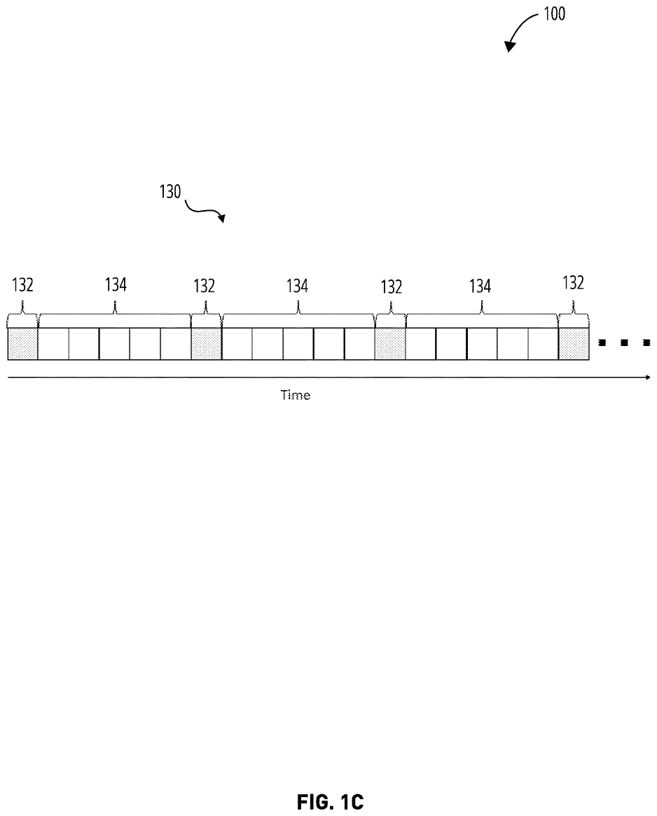

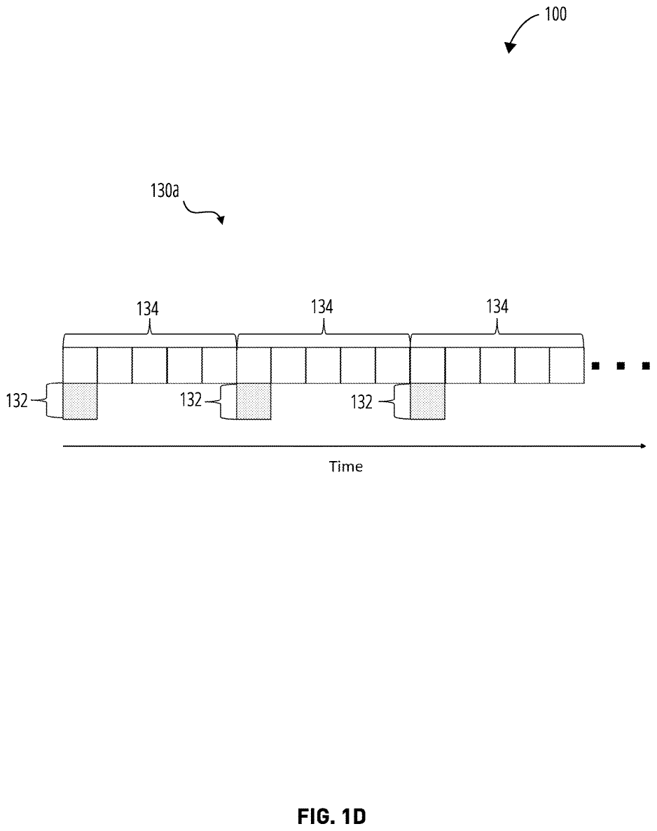

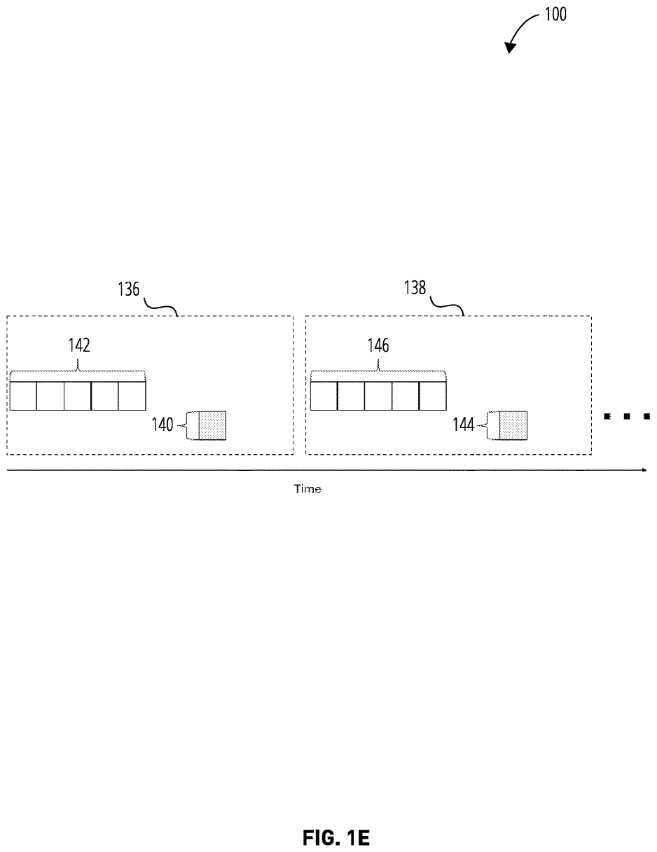

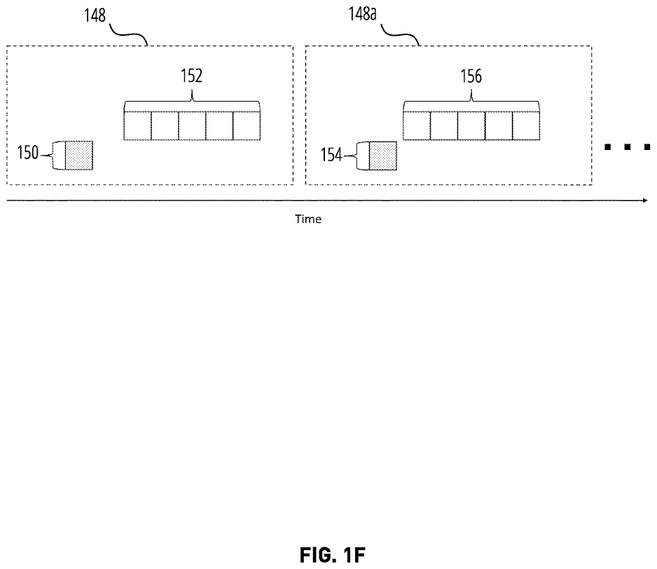

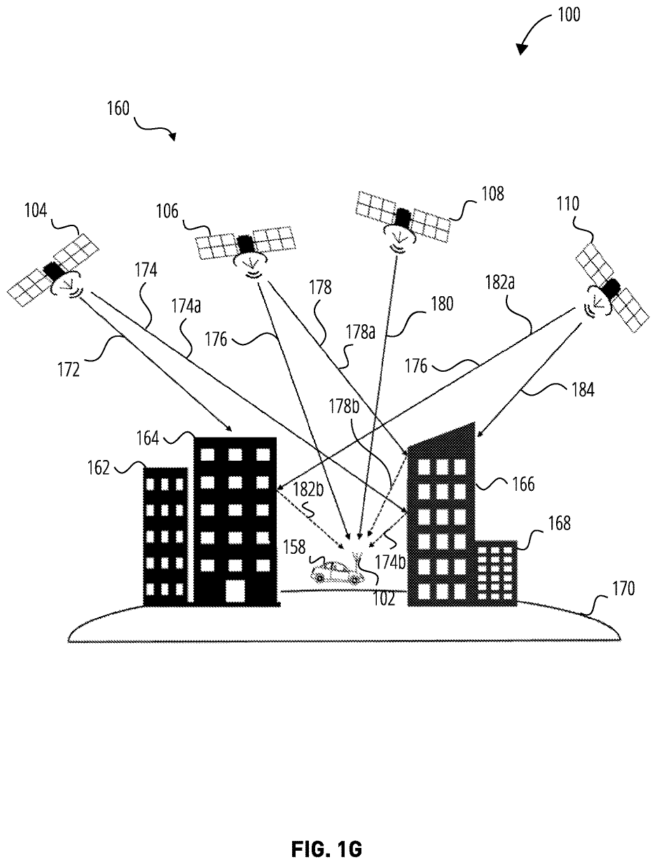

FIGS. 1A-1G are diagrams of an example 100 associated with enhanced multipath differentiation. As shown in FIG. 1A, the example 100 includes a transceiver device 102 (e.g., a user equipment (UE)), a first satellite 104 (e.g., a first GNSS satellite), a second satellite 106 (e.g., a second GNSS satellite), a third satellite 108 (e.g., a third GNSS satellite), and a fourth satellite 110 (e.g., a fourth GNSS satellite). The transceiver device 102, the first satellite 104, the second satellite 106, the third satellite 108, and the fourth satellite 110 may form an enhanced multipath differentiation architecture, as described in more detail elsewhere herein.

As shown in FIG. 1A, the first satellite 104 transmits a first signal set 112, the second satellite 106 transmits a second signal set 114, the third satellite 108 transmits a third signal set 116, and the fourth satellite 110 transmits a fourth signal set 118. The transceiver device 102 receives the first signal set 112, the second signal set 114, the third signal set 116, and the fourth signal set 118. The spread spectrum signals and/or the LFM signals may be transmitted synchronously, asynchronously, and/or in any suitable manner.

In some implementations, each of the first signal set 112, the second signal set 114, the third signal set 116, and the fourth signal set 118 includes a spread spectrum signal and a corresponding linear frequency modulated (LFM) signal. As an example, each of the first signal set 112, the second signal set 114, the third signal set 116, and the fourth signal set 118 may include a DSSS signal and a corresponding linear chirp waveform (e.g., a sinusoidal waveform having a frequency that increases or decreases linearly over time, as described in more detail elsewhere herein).

In some implementations, the spread spectrum signals and/or the LFM signals may be generated (e.g., by a waveform generator, among other examples), using one or more waveform generation techniques, using one or more modulation techniques, and/or to conform to one or more access scheme requirements, among other examples. As an example, the waveform generator may produce spread spectrum signals by generating carrier signals at specific frequencies, such as those found in L1 bands operating at a frequency of around 1575.42 MHz or L5 bands operating at a frequency of around 1176.45 MHz, among other examples. The waveform generator may modulate the carrier signals with spreading codes (e.g., coarse/acquisition C/A codes for the L1 band having a chipping rate of 1.023 megachips per second (Mcps) among other examples). The waveform generator may encode navigation messages (e.g., including PVT information) onto the carrier signals using one or more modulation techniques, such as binary phase-shift keying (BPSK). The waveform generator may amplify the spread spectrum signals to achieve the desired power level before providing the spread spectrum signals as an output (e.g., to the first satellite 104, the second satellite 106, the third satellite 108, and the fourth satellite 110).

As another example, the waveform generator may generate LFM signals by generating precise and stable frequency signals (e.g., using direct digital synthesis (DDS) techniques, voltage-controlled oscillator (VCOs) techniques, and/or or phase-locked loop (PLL) techniques, among other examples. These waveforms have frequencies that change linearly over time with adjustable parameters such as start frequencies, end frequencies, sweep rates, and durations. FIG. 1B illustrates a first spectrograph 122 where an LFM signal has a continuous positive slope frequency over a single time period, a second spectrograph 124 where an LFM signal has a continuous negative slope frequency over a single time period, a third spectrograph 126 where an LFM signal has a multiple positive frequency slopes over multiple time periods (e.g., discontinuous positive frequency slopes), and a fourth spectrograph 128 where an LFM signal has a continuous frequency slope including a positive frequency slope for a first time period, a zero frequency slope for a second time period, a negative frequency slope for a third time period (e.g., having no change in the frequency slope), and a zero frequency slope for a fourth time period.

Although various frequency slopes of LFM signals are illustrated in the spectrographs 122, 124, 126, and 128 of FIG. 1B, the LFM signals may have any suitable frequency slopes. The waveform generator may amplify power levels of the LFM signals before providing the LFM signals as an output (e.g., to the first satellite 104, the second satellite 106, the third satellite 108, and the fourth satellite). The spread spectrum signals and/or the LFM signals (e.g., generated by the waveform generator and transmitted by the first satellite 104, the second satellite 106, the third satellite 108, and/or the fourth satellite 110) may include any suitable permutations of signal types that are based on any suitable modulation techniques (e.g., DSSS and/or chirp spread spectrum (CSS)), access schemes (e.g., code division multiple access (CDMA) and/or time division multiple access (TDMA)), and/or protocols (e.g., system specific protocols), and/or any suitable combination of modulation techniques, access schemes, and/or protocols among other examples.

In some implementations, the first signal set 112, the second signal set 114, the third signal set 116, and/or the fourth signal set 118 may include multipath signals. As an example, and as shown in FIG. 1A, the third signal set 116 includes multipath signals that are received by the transceiver device 102 via a direct line-of-sight path 116a and multipath signals that are received via an indirect non-line-of-sight path 116b. In other words, the spread spectrum signal and the corresponding LFM signal, transmitted by the third satellite 108, are reflected from a surface of an object 120 before being received by the transceiver device 102. Accordingly, the third signal set 116 includes directly received signal components of the spread spectrum signal and the LFM signal (e.g., related to the spread spectrum signal and the LFM signal traveling along the direct line-of-sight path 116a) and indirectly received signal components of the spread spectrum signal and the LFM signal (e.g., related to the spread spectrum signal and the LFM signal traveling along the indirect non-line-of-sight path 116b).

In some implementations, the transceiver device 102 may receive signal information associated with the transmission times of the first signal set 112, the second signal set 114, the third signal set 116, and the fourth signal set 118 and transmission positions from which the first signal set 112, the second signal set 114, the third signal set 116, and the fourth signal set 118 were transmitted from, as described in more detail elsewhere herein. The transceiver device 102 may process the signal information to derive PVT solutions related to the transceiver device 102, the first satellite 104, the second satellite 106, the third satellite 108, the fourth satellite 110, and/or the object 120, as described in more detail elsewhere herein.

As an example, the UE 102 may process the first signal set 112, the second signal set 114, the third signal set 116, and the fourth signal set 118 to derive a position of the UE 102, a time at which the UE 102 was at the position, a first transmission time of the first signal set 112, a first position of the first satellite 104 at the first transmission time, a second transmission time of the second signal set 114, a second position of the second satellite 106 at the second transmission time, a third transmission time of the third signal set 116, a third position of the third satellite 108 at the third transmission time, a fourth transmission time of the fourth signal set 118, a fourth position of the fourth satellite 110 at the fourth transmission, a first range to the object 120 (e.g., a range to a surface of the object that reflects the third signal set 116) relative to the transceiver device 102, a fifth time at which the object 120 was at the range, a direction of the object 120 relative to the position of the transceiver device 102, and/or a velocity of the object 120 relative to the transceiver device 102, among other examples, as described in more detail elsewhere herein.

In some implementations, the transceiver device 102 receives signal information indicating transmission times of the spread spectrum signals and the LFM signals and transmission positions from which the spread spectrum signals and the LFM signals were transmitted via navigation messages included in the spread spectrum signals. For example, the spread spectrum signal of the first signal set 112 may include a first navigation message indicating a first transmission time of the spread spectrum signal and the LFM signal (e.g., included in the first signal set 112) and a first transmission position from which the spread spectrum signal and the LFM signal were transmitted (e.g., by the first satellite 104).

As another example, the spread spectrum signal of the second signal set 114 may include a second navigation message indicating a second transmission time of the spread spectrum signal and the LFM signal (e.g., included in the second signal set 114) and a second transmission position from which the spread spectrum signal and the LFM signal were transmitted (e.g., by the second satellite 106).

As another example, the spread spectrum signal of the third signal set 116 may include a third navigation message indicating a third transmission time of the spread spectrum signal and the LFM signal (e.g., included in the third signal set 116) and a third transmission position from which the spread spectrum signal and the LFM signal were transmitted (e.g., by the third satellite 108). As yet another example, the spread spectrum signal of the fourth signal set 118 may include a fourth navigation message indicating a fourth transmission time of the spread spectrum signal and the LFM signal (e.g., included in the fourth signal set 118) and a fourth transmission position from which the spread spectrum signal and the LFM signal were transmitted (e.g., by the fourth satellite 110).

Although the transceiver device 102 is described as receiving the signal information indicating the transmission times of the spread spectrum signals and the LFM signals and the transmission positions from which the spread spectrum signals and the LFM signals were transmitted via navigation messages included in the spread spectrum signals (e.g., that are transmitted by the first satellite 104, the second satellite 106, the third satellite 108, and the fourth satellite 110), the transceiver device 102 may receive the signal information in any suitable manner. For example, the transceiver device 102 may receive the signal information via a wired or wireless network (or connection). As an example, the transceiver device 102 may receive the signal information via an Internet connection, via a memory device (e.g., a hard drive and/or a digital database, among other examples), and/or via a peer-to-peer network, among other examples. Furthermore, the transceiver device 102 may receive the signal information before the spread spectrum signals and/or the LFM signals are transmitted, after the spread spectrum signals and/or the LFM signals are transmitted, and/or at any other suitable time.

Although the spread spectrum signal and the corresponding LFM signal (e.g., included in each of the first signal set 112, the second signal set 114, the third signal set 116, and the fourth signal set 118) are described as being transmitted at a single transmission time, the spread spectrum signal and the corresponding LFM signal may be transmitted at separate times (e.g., the navigation message may indicate a first transmission time of the spread spectrum signal and a second transmission time of the corresponding LFM signal that is earlier in time or later in time than the first transmission time). Similarly, although the spread spectrum signal and the corresponding LFM signal (e.g., included in each of the first signal set 112, the second signal set 114, the third signal set 116, and the fourth signal set 118) are described as being transmitted from a single position, the spread signal and the corresponding LFM signal may be transmitted from different positions (e.g., the navigation message may indicate a first transmission position from which the spread spectrum signal was transmitted from and a second transmission position from which the corresponding LFM signal was, or is to be, transmitted from).

Additionally, or alternatively, the navigation message may indicate a transmission time of one or more different signals (e.g., a spread spectrum signal and/or an LFM signal included in a different signal set) and/or a transmission position from which the one or more different signals was, or is to be, transmitted from. Although the transceiver device 102 is described as receiving the signal information indicating the transmission times of the spread spectrum signals and the LFM signals and the transmission positions from which the spread spectrum signals and the LFM signals were, or are to be, transmitted via navigation messages of the spread spectrum signals, the transceiver device 102 may receive the signal information in any suitable manner. As an example, the transceiver device 102 may receive the signal information from a server device (e.g., via a wired or wireless network connection), among other examples. The transceiver device 102 may determine the transmission time and the transmission position from which the LFM signal was, or is to be, transmitted from (e.g., at the transmission time) based on the signal information.

In some implementations, the spread spectrum signal and the LFM signal (e.g., included in each of the first signal set 112, the second signal set 114, the third signal set 116, and the fourth signal set 118) may be transmitted as a hybrid signal, such as a hybrid signal including a spread spectrum signal and an LFM signal, as described in more detail elsewhere herein). As shown in FIG. 1C, a first hybrid signal 130 includes linear chirp waveforms 132 and DSSS signals 134 that are time aligned sequentially. As shown in FIG. 1D, a second hybrid signal 130a includes linear chirp waveforms 132 and DSSS signals 134 that are time aligned concurrently.

As shown in FIG. 1E, a first hybrid signal set 136 includes a first linear chirp waveform 140 corresponding to a first DSSS signal 142 that is transmitted later in time than a time when the first DSSS signal 142 is transmitted. As further shown in FIG. 1E, a second hybrid signal set 138 includes a second linear chirp waveform 144 corresponding to a second DSSS signal 146 that is transmitted later in time than a time when the second DSSS signal 146 is transmitted.

As shown in FIG. 1F, a first hybrid signal set 148 includes a first linear chirp waveform 150 corresponding to a first DSSS signal 152 that is transmitted earlier in time than a time when the first DSSS signal 152 is transmitted. As further shown in FIG. 1F, a second hybrid signal set 148a includes a second linear chirp waveform 154 corresponding to a second DSSS signal 156 that is transmitted earlier in time than a time when the first DSSS signal 156 is transmitted. Although particular hybrid signals and hybrid signal sets are shown and described in connection with FIGS. 1C-1F, the spread spectrum signals (e.g., the DSSS signals) and/or the LFM signals may be transmitted in any suitable manner. Furthermore, although DSSS signals and LFM signals are described as hybrid signals and hybrid signal sets in connection with FIGS. 1C-1E, the DSSS signals may be associated with any suitable linear chirp waveforms (e.g., a navigation message included in a DSSS signal may indicate transmission times related to multiple linear chirp waveforms and transmission positions from which the multiple linear chirp waveforms were, or are to be, transmitted from).

In some implementations, the first signal set 112, the second signal set 114, the third signal set 116, and/or the fourth signal set 118 may include multipath signals. As an example, and as shown in FIG. 1A, the third signal set 116 includes multipath signals that are received by the transceiver device 102 via a direct line-of-sight path 116a and multipath signals that are received via an indirect non-line-of-sight path 116b. In other words, the spread spectrum signal and the corresponding LFM signal, transmitted by the third satellite 108, are reflected from a surface of an object 120 before being received by the transceiver device 102. Accordingly, the third signal set 116 includes directly received signal components of the spread spectrum signal and the LFM signal (e.g., related to the spread spectrum signal and the LFM signal traveling along the direct line-of-sight path 116a) and indirectly received signal components of the spread spectrum signal and the LFM signal (e.g., related to the spread spectrum signal and the LFM signal traveling along the indirect non-line-of-sight path 116b).

In some implementations, the transceiver device 102 may process the first signal set 112, the second signal set 114, the third signal set 116, and the fourth signal set 118 to derive position, velocity, and time (PVT) information related to the transceiver device 102, the first satellite 104, the second satellite 106, the third satellite 108, the fourth satellite 110, and/or the object 120. As an example, the transceiver device 102 may process the first signal set 112, the second signal set 114, the third signal set 116, and the fourth signal set 118 to derive a position of the transceiver device 102, a time at which the transceiver device 102 was at the position, a first transmission time of the first signal set 112, a first position of the first satellite 104 at the first transmission time, a second transmission time of the second signal set 114, a second position of the second satellite 106 at the second transmission time, a third transmission time of the third signal set 116, a third position of the third satellite 108 at the third transmission time, a fourth transmission time of the fourth signal set 118, a fourth position of the fourth satellite 110 at the fourth transmission, a first range to the object 120 (e.g., a range to a surface of the object that reflects the third signal set 116) relative to the transceiver device 102, and a fifth time at which the object 120 was at the range, among other examples, as described in more detail elsewhere herein.

In this way, the transceiver device 102 may perform enhanced multipath differentiation techniques to differentiate multipath signals from directly received signals (e.g., because the transceiver device 102 receives information enabling the transceiver device to determine a time difference of arrival between arrival times of the directly received signal components of the LFM signals and the indirectly received signal components of the LFM signals). As a result, the transceiver device 102 may process the LFM signals, in addition to the spread spectrum signals, to derive more precise PVT solutions (e.g., more precise determinations of a position of the transceiver device 102 and a time at which the transceiver device 102 was at the position) compared to typical multipath processing techniques. Additionally, or alternatively, because the transceiver device 102 can perform enhanced multipath differentiation (e.g., based on accurately and efficiently differentiating between the directly received signal components of the LFM signals and the indirectly received components of the LFM signals), the transceiver device 102 can accurately and efficiently locate and/or track objects in close proximity to the transceiver device 102 (e.g. a building that is in close proximity to the transceiver device 102), as described in more detail elsewhere herein.

As shown in FIG. 1G, the enhanced multipath differentiation architecture (e.g., formed by the transceiver device 102, the first satellite 104, the second satellite 106, the third satellite 108, and the fourth satellite 110) may be used by a vehicle 158 (e.g., an autonomous or non-autonomous vehicle) traveling along a trajectory in an urban environment 160. The urban environment 160 includes a first building 162, a second building 164, a third building 166, and a fourth building 168, each of which being located on a ground surface 170.

As shown in FIG. 1G, the first satellite 104 transmits a first signal set 172 and a second signal set 174, the second satellite 106 transmits a third signal set 176 and a fourth signal set 178, the third satellite 108 transmits a fifth signal set 180, and the fourth satellite 110 transmits a sixth signal set 182 and a seventh signal set 184. The first signal set 172, the second signal set 174, the third signal set 176, the fourth signal set 178, the fifth signal set 180, the sixth signal set 182 and the seventh signal set 184 may include spread spectrum signals and LFM signals, as described in more detail elsewhere herein.

As shown in FIG. 1G, the first signal set 172 is blocked by the second building 164, and, therefore, is not received by the transceiver device 102. The second signal set 174 includes multipath signals that are received by the transceiver device 102 via a direct line-of-sight path 174a and multipath signals that are received via an indirect non-line-of-sight path 174b (e.g., reflected from a surface of the third building 166). The third signal set 176 is directly received by the transceiver device 102. The fourth signal set 178 includes multipath signals that are received by the transceiver device 102 via a direct line-of-sight path 178a and multipath signals that are received via an indirect non-line-of-sight path 178b (e.g., reflected from a surface of the third building 166). The fifth signal set 180 is directly received by the transceiver device 102. The sixth signal set 182 includes multipath signals that are received by the transceiver device 102 via a direct line-of-sight path 182a and multipath signals that are received via an indirect non-line-of-sight path 182b (e.g., reflected from a surface of the second building 164). The seventh signal set 184 is blocked by the third building 166, and, therefore, is not received by the transceiver device 102.

The transceiver device 102 may receive signal information related to the received signals, as described in more detail elsewhere herein. The transceiver device 102 may process, based on the signal information, the received signals to estimate (e.g., based on the transmission times and the transmission positions of the received signals), a position of the transceiver device (e.g., which corresponds to a vehicle position of the vehicle 158), a time at which the transceiver device 102 was at the position (e.g., which corresponds to a time at which the vehicle was at the vehicle position, times of arrival of the directly received signal components and the indirectly received signal components, and time differences of arrival between the times of arrival of the directly received signal components and the indirectly received signal components. The transceiver device 102 may estimate (e.g., based on the transmission positions, the position of the device, and the time difference of arrivals, ranges to the surfaces (e.g., the surfaces of the second building 164 and the third building 166 that reflect the indirectly received signal components) relative to the position of the transceiver device 102 (e.g., relative to the vehicle position of the vehicle 158).

In this way, the transceiver device 102 may process the LFM signals, in addition to the spread spectrum signals, to derive more precise PVT solutions (e.g., more precise determinations of a position of the transceiver device 102 and a time at which the transceiver device 102 was at the position) compared to typical multipath processing techniques. Additionally, or alternatively, because the transceiver device 102 can perform enhanced multipath differentiation (e.g., based on accurately and efficiently differentiating between the directly received signal components of the LFM signals and the indirectly received components of the LFM signals), the transceiver device 102 can accurately and efficiently locate and/or track objects in close proximity to the transceiver device 102 (e.g. a building that is in close proximity to the transceiver device 102), as described in more detail elsewhere herein.

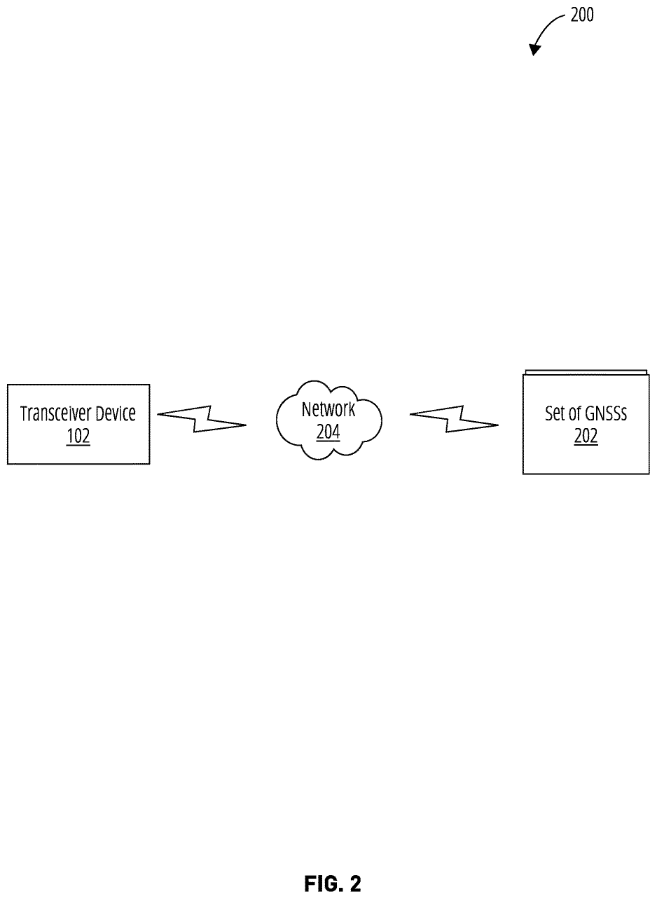

FIG. 2 is a diagram of an example environment 200 in which systems and/or methods described herein may be implemented. As shown in FIG. 2, environment 200 may include a transceiver device 102, a set of GNSS satellites 202, and a network 204. Devices of environment 200 may interconnect via wired connections, wireless connections, or a combination of wired and wireless connections.

The transceiver device 102 may include one or more devices capable of receiving, generating, storing, processing, providing, and/or routing information associated with enhanced multipath differentiation, as described elsewhere herein. The transceiver device 102 may include a communication device and/or a computer. For example, the transceiver device 102 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset, among other examples), or a similar type of device.

The set of GNSS satellites 202 may include a set, or constellation, of satellites in orbit (e.g., around Earth) that provide positioning, navigation, and timing information via spread spectrum signals (e.g., DSSS signals, among other examples) and LFM signals (e.g., linear chirp waveforms, among other examples). The spread spectrum signals and the LFM signals may be received and processed by ground-based receivers (e.g., the transceiver device 102 and/or a user equipment (UE), among other examples), enabling accurate determination of positions and precise timekeeping and enhanced multipath differentiation.

The network 204 may include one or more wired and/or wireless networks. For example, the network 204 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 204 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

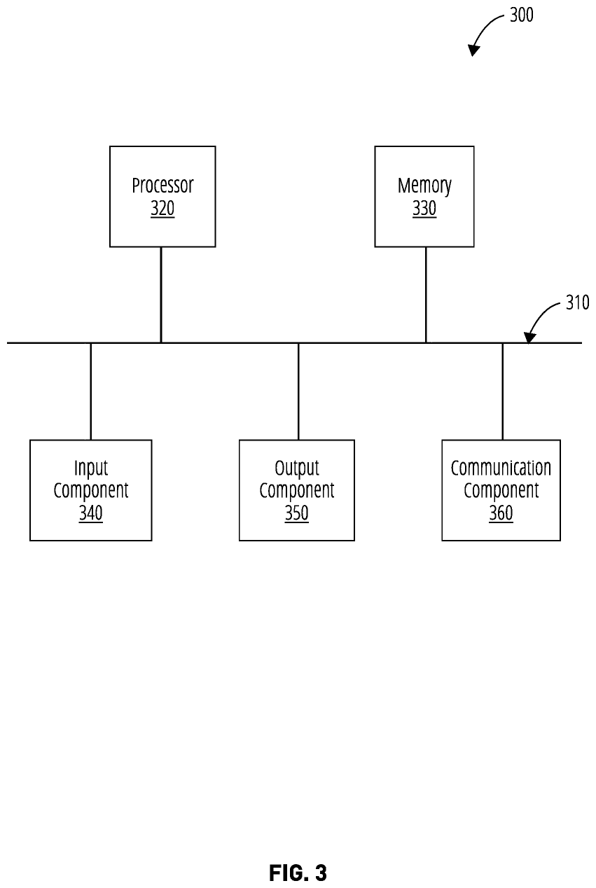

FIG. 3 is a diagram of example components of a device 300 associated with enhanced multipath differentiation. The device 300 may correspond to the transceiver device 102, the first satellite 104, the second satellite 106, the third satellite 108, the fourth satellite 110, and/or the set of GNSS satellites 202. In some implementations, the transceiver device 102, the first satellite 104, the second satellite 106, the third satellite 108, the fourth satellite 110, and/or the set of GNSS satellites 202 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, and/or software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

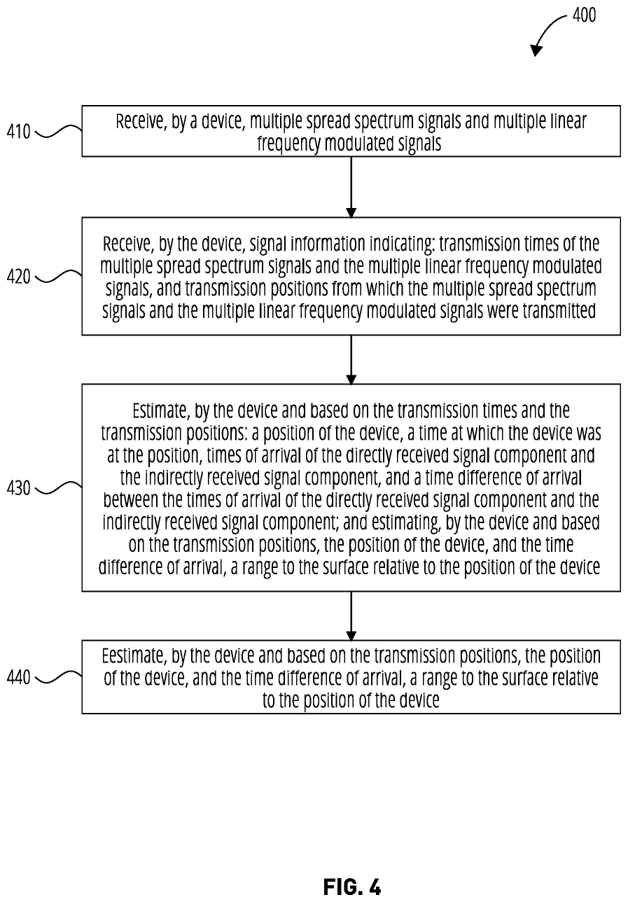

FIG. 4 is a flowchart of an example process 400 associated with enhanced multipath differentiation. In some implementations, one or more process blocks of FIG. 4 may be performed by the transceiver device 102. In some implementations, one or more process blocks of FIG. 4 may be performed by another device (e.g., the first satellite 104, the second satellite 106, the third satellite 108, the fourth satellite 110, and/or the set of GNSS satellites 202) or a group of devices separate from or including the transceiver device 102. Additionally, or alternatively, one or more process blocks of FIG. 4 may be performed by one or more components of the device 300, such as the processor 320, the memory 330, the input component 340, the output component 340, and/or the communication component 360.

As shown in FIG. 4, the process 400 includes receiving, by a device, multiple spread spectrum signals and multiple linear frequency modulated signals (block 410), as described above. The multiple linear frequency modulated signals may include a multipath linear frequency modulated signal having a directly received signal component and an indirectly received signal component. The indirectly received signal component may be reflected from a surface.

As further shown in FIG. 4, the process 400 includes receiving, by the device, signal information indicating: transmission times of the multiple spread spectrum signals and the multiple linear frequency modulated signals, and transmission positions from which the multiple spread spectrum signals and the multiple linear frequency modulated signals were transmitted (block 420), as described above.

As further shown in FIG. 4, the process 400 includes estimating, by the device and based on the transmission times and the transmission positions: a position of the device, a time at which the device was at the position, times of arrival of the directly received signal component and the indirectly received signal component, and a time difference of arrival between the times of arrival of the directly received signal component and the indirectly received signal component (block 430), as described above.

As further shown in FIG. 4, the process 400 includes estimating, by the device and based on the transmission positions, the position of the device, and the time difference of arrival, a range to the surface relative to the position of the device (block 440), as described above.

Although FIG. 4 shows example blocks of the process 400, in some implementations, the process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, and/or software. It will be apparent that systems and/or methods described herein may be implemented in different forms of hardware, firmware, and/or software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, multiple spread spectrum signals and multiple linear frequency modulated signals,
wherein the multiple linear frequency modulated signals include a multipath linear frequency modulated signal having a directly received signal component and an indirectly received signal component, and
wherein the indirectly received signal component is reflected from a surface;
receiving signal information indicating:
transmission times of the multiple spread spectrum signals and the multiple linear frequency modulated signals, and
transmission positions from which the multiple spread spectrum signals and the multiple linear frequency modulated signals were transmitted;
estimating, by the device and based on the transmission times and the transmission positions:
a position of the device,
a time at which the device was at the position,
times of arrival of the directly received signal component and the indirectly received signal component, and
a time difference of arrival between the times of arrival of the directly received signal component and the indirectly received signal component; and
estimating, by the device and based on the transmission positions, the position of the device, and the time difference of arrival, a range to the surface relative to the position of the device.

2. The method of claim 1, wherein the multiple spread spectrum signals and the multiple linear frequency modulated signals are corresponding signal pairs, and
wherein each corresponding signal pair, of the corresponding signal pairs, are time synchronized to one another.

3. The method of claim 1, wherein the multiple spread spectrum signals and the multiple linear frequency modulated signals are received at least one of:
synchronously, or
asynchronously.

4. The method of claim 1, a frequency of at least one multiple linear frequency modulated signal, of the multiple linear frequency modulated signals, includes a first frequency component and a second frequency component that is different than the first frequency component.

5. The method of claim 1, wherein the signal information is included in navigation messages of the multiple spread spectrum signals.

6. The method of claim 1, wherein the spread spectrum signals are direct sequence spread spectrum signals.

7. The method of claim 1, further comprising:
adjusting, by the device and based on the range, a trajectory of the device.

8. A transceiver device, comprising:
one or more memories; and
one or more processors, communicatively coupled to the one or more memories, configured to:
receive multiple spread spectrum signals corresponding to multiple linear frequency modulated signals,
wherein the multiple linear frequency modulated signals include a multipath linear frequency modulated signal having a directly received signal component and an indirectly received signal component, and
wherein the indirectly received signal component is reflected from a surface;
receive signal information indicating:
transmission times of the multiple spread spectrum signals and the multiple linear frequency modulated signals, and
transmission positions from which the multiple spread spectrum signals and the multiple linear frequency modulated signals were transmitted;
estimate, based on the transmission times and the transmission positions:
a position of the transceiver device,
a time at which the transceiver device was at the position,
times of arrival of the directly received signal component and the indirectly received signal component, and
a time difference of arrival between the times of arrival of the directly received signal component and the indirectly received signal component; and
estimate, based on the transmission positions, the position of the device, and the time difference of arrival, a range to the surface relative to the position of the device.

9. The transceiver device of claim 8, wherein the multiple spread spectrum signals and the multiple linear frequency modulated signals are corresponding signal pairs, and
wherein each corresponding signal pair, of the corresponding signal pairs, are time synchronized to one another.

10. The transceiver device of claim 8, wherein the multiple spread spectrum signals and the multiple linear frequency modulated signals are received by the transceiver device at least one of:
concurrently, or
sequentially.

11. The transceiver device of claim 8, wherein a frequency of at least one multiple linear frequency modulated signal, of the multiple linear frequency modulated signals, includes a first frequency component and a second frequency component that is different than the first frequency component.

12. The transceiver device of claim 8, wherein the signal information is included in navigation messages of the multiple spread spectrum signals.

13. The transceiver device of claim 8, wherein the spread spectrum signals are direct sequence spread spectrum signals.

14. The transceiver device of claim 8, wherein the one or more processors are configured to:
adjust, based on the range, a trajectory of the device.

15. A non-transitory computer-readable medium storing a set of instructions, the set of instructions comprising:
one or more instructions that, when executed by one or more processors of a device, cause the device to:
receive multiple spread spectrum signals corresponding to multiple linear frequency modulated signals,
wherein the multiple linear frequency modulated signals include a multipath linear frequency modulated signal having a directly received signal component and an indirectly received signal component, and
wherein the indirectly received signal component is reflected from a surface;
receive signal information indicating:
transmission times of the multiple spread spectrum signals and the multiple linear frequency modulated signals, and
transmission positions from which the multiple spread spectrum signals and the multiple linear frequency modulated signals were transmitted;
estimate, based on the transmission times and the transmission positions:
a position of the device,
a time at which the device was at the position,
times of arrival of the directly received signal component and the indirectly received signal component, and
a time difference of arrival between the times of arrival of the directly received signal component and the indirectly received signal component; and
estimate, based on the transmission positions, the position of the device, and the time difference of arrival, a range to the surface relative to the position of the device.

16. The non-transitory computer-readable medium of claim 15, wherein the multiple spread spectrum signals and the multiple linear frequency modulated signals are corresponding signal pairs, and
wherein each corresponding signal pair, of the corresponding signal pairs, are time synchronized to one another.

17. The non-transitory computer-readable medium of claim 15, wherein the multiple spread spectrum signals and the multiple linear frequency modulated signals are received at least one of:
concurrently, or
sequentially.

18. The non-transitory computer-readable medium of claim 15, wherein a frequency of at least one multiple linear frequency modulated signal, of the multiple linear frequency modulated signals, includes a first frequency component and a second frequency component that is different than the first frequency component.

19. The non-transitory computer-readable medium of claim 15, wherein the signal information is included in navigation messages of the multiple spread spectrum signals.

20. The non-transitory computer-readable medium of claim 15, wherein the spread spectrum signals are direct sequence spread spectrum signals.
